(19) United States
(12) Patent Application Publication
(10) Pub. No.: US 2026/0329578 A1
(43) Pub. Date: Oct. 22, 2026

(54) MANAGEMENT DEVICE, MANAGEMENT METHOD, AND NON-TRANSITORY COMPUTER-READABLE RECORDING MEDIUM

(71) Applicant: NEC Corporation, Tokyo (JP)

(72) Inventor: Yo ASAHARA, Tokyo (JP)

(73) Assignee: NEC Corporation, Tokyo (JP)

(21) Appl. No.: 19/642,962

(22) Filed: Apr. 9, 2026

(30) Foreign Application Priority Data
Apr. 21, 2025 (JP) 2025-069777

(51) Int. Cl. G06F 8/70; G06F 21/57; G06F 21/62

(52) U.S. Cl. CPC G06F 8/70; G06F 21/57; G06F 21/6209; G06F 2221/2141

(57) ABSTRACT

A management device according to an aspect of the present disclosure includes a reception unit that receive a selection of a project related to development, and a display control unit that display a checklist including one or more implementation items indicating one or more measures related to cybersecurity to be implemented for the selected project, wherein the display control unit displays, for each phase of the selected project, the one or more implementation items and a state of implementation of the one or more measures based on input information for the checklist.

### CROSS REFERENCE TO THE RELATE4D APPLICATIONS

This application is based upon and claims the benefit of priority from Japanese Patent Application No. 2025-069777, filed on April 21, 2025, the disclosure of which is incorporated herein in its entirety by reference.

### TECHNICAL FIELD

The present disclosure relates to a management device, a management method, and a program.

### BACKGROUND ART

Negative risks may exist in various work activities. Techniques related to analysis of negative risks are known.

JP 2008-102859 A discloses identifying threats or vulnerabilities for a risk analysis target business entity, and performing a risk analysis related to information security using a computer based on the results. For example, JP 2008-102859 A discloses generating a checklist indicating a questionnaire regarding work activities in the risk analysis target business entity, and identifying the threats and vulnerabilities by analyzing the answered checklist.

### SUMMARY

A management device according to an aspect of the present disclosure includes a reception unit that receive a selection of a project related to development, and a display control unit that display a checklist including one or more implementation items indicating one or more measures related to cybersecurity to be implemented for the selected project, wherein the display control unit displays, for each phase of the selected project, the one or more implementation items and a state of implementation of the one or more measures based on input information for the checklist.

A management method according to an aspect of the present disclosure includes receiving a selection of a project related to development, and displaying a checklist including one or more implementation items indicating one or more measures related to cybersecurity to be implemented for the selected project, wherein the displaying includes displaying, for each phase of the selected project, the one or more implementation items and a state of implementation of the one or more measures based on input information for the checklist.

A non-transitory computer-readable recording medium storing a program according to an aspect of the present disclosure causes a computer to execute receiving a selection of a project related to development, and displaying a checklist including one or more implementation items indicating one or more measures related to cybersecurity to be implemented for the selected project, wherein the displaying includes displaying, for each phase of the selected project, the one or more implementation items and a state of implementation of the one or more measures based on input information for the checklist.

### BRIEF DESCRIPTION OF THE DRAWINGS

FIG. 1 is a block diagram illustrating an example of a functional configuration of a management device according to the present disclosure;

FIG. 2 is a flowchart showing an example of an operation of the management device according to the present disclosure;

FIG. 3 is a diagram schematically illustrating an example of a configuration including the management device according to the present disclosure;

FIG. 4 is a block diagram including an example of a functional configuration of the management device according to the present disclosure;

FIG. 5 is a diagram illustrating an example of project information according to the present disclosure;

FIG. 6 is a diagram illustrating an example of role information according to the present disclosure;

FIG. 7 is a first diagram illustrating an example of output information according to the present disclosure;

FIG. 8 is a second diagram illustrating an example of output information according to the present disclosure;

FIG. 9 is a third diagram illustrating an example of output information according to the present disclosure;

FIG. 10 is a fourth diagram illustrating an example of output information according to the present disclosure;

FIG. 11 is a fifth diagram illustrating an example of output information according to the present disclosure;

FIG. 12 is a sixth diagram illustrating an example of output information according to the present disclosure;

FIG. 13 is a seventh diagram illustrating an example of output information according to the present disclosure;

FIG. 14 is an eighth diagram illustrating an example of output information according to the present disclosure;

FIG. 15 is a ninth diagram illustrating an example of output information according to the present disclosure;

FIG. 16 is a tenth diagram illustrating an example of output information according to the present disclosure;

FIG. 17 is an eleventh diagram illustrating an example of output information according to the present disclosure;

FIG. 18 is a twelfth diagram illustrating an example of output information according to the present disclosure;

FIG. 19 is a thirteenth diagram illustrating an example of output information according to the present disclosure; and

FIG. 20 is a block diagram illustrating an example of a hardware configuration of a computer device that implements a management device according to the present disclosure.

### EXAMPLE EMBODIMENT

Hereinafter, example embodiments of the present disclosure will be described with reference to the drawings.

### First Example Embodiment

An outline of a management device according to a first example embodiment will be described.

An example of the management device of the present disclosure is a device that presents a checklist regarding measures to be implemented for a project. Here, the project in the present disclosure is a project capable of implementing measures regarding cybersecurity. For example, it is a project related to development of a digital product. The digital product includes a product, a system, and a service for which measures related to cybersecurity should be implemented. The project may include stages before development such as planning and proposal, and stages after development such as shipment, operation, and maintenance.

The checklist is data regarding implementation items for measures related to cybersecurity. More specifically, the checklist may be data in which actions to be implemented in the project for cybersecurity purposes are indicated as confirm items. For example, a person such as a security practitioner for the project confirms the implementation items of the measures related to cybersecurity implemented for the project, and inputs details regarding implementation of the measures to the checklist. As described above, the checklist includes implementation items indicating measures to be implemented for the project. For example, the management device is capable of presenting a checklist to receive such an input or presenting the checklist after the input.

As used herein, cybersecurity may be simply referred to as “security”. Measures related to cybersecurity may be simply referred to as "measures”.

The management device in the present disclosure is implemented in, for example, a server device. The management device may be implemented in a cloud server. The management device is communicably connected to various devices via a wired or wireless network. For example, the management device is communicably connected to a terminal device. The terminal device is a device having an input/output function operated by a user. The terminal device may be a personal computer, a smartphone, a tablet terminal, or the like. The management device may output information to the terminal device. More specifically, the management device may cause a terminal to display various types of information by outputting various types of information to the terminal. The management device is not limited to this example. For example, the management device may be implemented in a terminal device. In the present disclosure, an example in which the management device is implemented in a server device and is communicably connected to a terminal device will be mainly described.

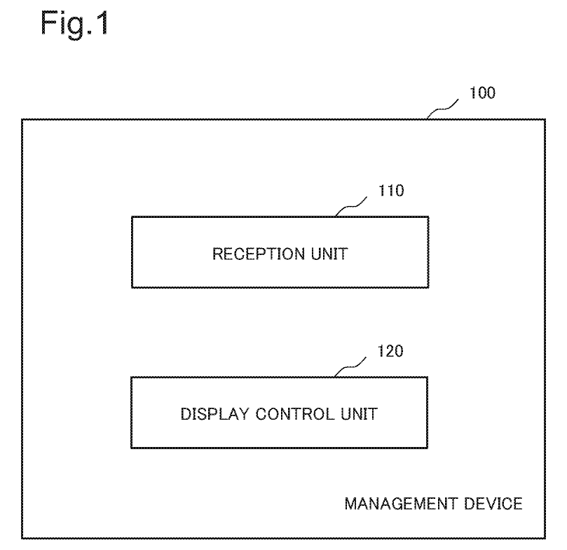

FIG. 1 is a block diagram illustrating an example of a functional configuration of the management device 100. As illustrated in FIG. 1, the management device 100 includes a reception unit 110 and a display control unit 120.

The reception unit 110 receives various inputs from the user. For example, the reception unit 110 receives the selection of a project. For example, information indicating one or more projects is displayed on the terminal device. The project may be related to development of a digital product. The user uses an input device of the terminal device to select one from among one or more pieces of information indicating projects. The reception unit 110 receives the selection operation input through the terminal device.

In this manner, the reception unit 110 receives the selection of a project related to development. The reception unit 110 is an example of a reception means.

The display control unit 120 displays various types of information. For example, the display control unit 120 displays a checklist related to the project. For example, the display control unit 120 causes the terminal device to display a checklist corresponding to the project selected by the user. The checklist includes implementation items indicating measures related to cybersecurity. In other words, the displayed checklist includes implementation items indicating measures to be implemented for the selected project.

Further, the checklist includes the state of implementation of the measures. The state of implementation is information based on input information for the checklist. The input information indicates details regarding the implementation of the measures input by the user when the user confirms the implementation of the measures using the checklist. For example, the user inputs information such as a state of implementation indicating whether measures indicated by implementation items have been implemented and implementation details indicating how the measures have been implemented or confirmed. That is, the state of implementation may include a state of implementation and implementation details for each implementation item, information indicating the number or proportion of measures that have been implemented, etc.

The checklist may be stored in a storage device included in the management device 100 or may be stored in an external device capable of communicating with the management device 100. At this time, the checklist is stored in association with information for identifying the project. The display control unit 120 may display, for example, a checklist associated with the identity information of the selected project.

As described above, the display control unit 120 displays a checklist including implementation items indicating measures regarding cybersecurity to be implemented for the selected project. The display control unit 120 is an example of a display control means.

In addition, the display control unit 120 may display the implementation items, the state of implementation, and the like in the checklist in a predetermined display mode. For example, the display control unit 120 displays the implementation items and state of implementation according to the phase of the project. A project may have a plurality of phases such as planning/proposal, requirement definition, design, and implementation. In addition, each phase has security measures to be implemented. For example, the display control unit 120 displays the implementation items and state of implementation for each phase. At this time, the checklist is associated with information indicating the corresponding phase for each implementation item. The display control unit 120 may display the implementation items and state of implementation corresponding to the phase to be advanced in the selected project.

In this manner, the display control unit 120 may display, for each phase in the selected project, the implementation items and the state of the implementation of measures, based on the input information for the checklist.

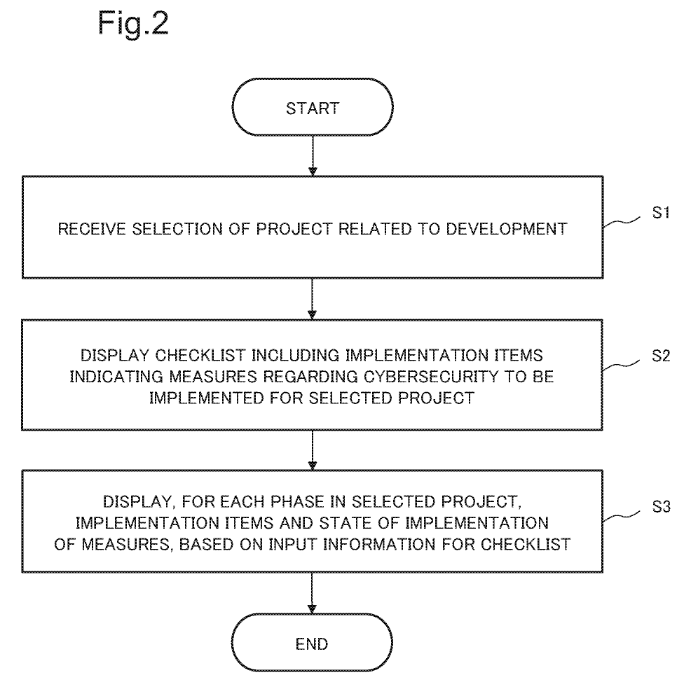

Next, an example of an operation of the management device 100 will be described with reference to FIG. 2. In the present disclosure, each step in the flowchart is represented using a number given to the step, such as “S1”.

FIG. 2 is a flowchart illustrating an example of the operation of the management device 100.

The reception unit 110 receives the selection of a project related to development (S1).

The display control unit 120 displays a checklist including implementation items indicating measures regarding cybersecurity to be implemented for the selected project (S2).

The display control unit 120 displays, for each phase in the selected project, the implementation items and the state of the implementation of measures, based on the input information for the checklist (S3).

In this manner, the management device 100 of the first example embodiment receives the selection of a project related to development. In addition, the management device 100 displays a checklist including implementation items indicating measures regarding cybersecurity to be implemented for the selected project. Furthermore, the management device 100 displays, for each phase in the selected project, the implementation items and the state of the implementation of measures, based on the input information for the checklist.

As a result, it is possible for the management device 100 to present a checklist corresponding to a desired project to the user. Then, it is possible for the management device 100 to present the implementation items and the state of implementation corresponding to the phase in the selected project. For example, since the management device 100 allows the user to easily understand the correspondence between the phases in the desired project and the implementation items, it is possible to promote efficient checklist input. In addition, for example, since the management device 100 allows the user to easily understand the state of progress or the like of the measure in each phase of the desired project, it is possible to promote efficient monitoring of the progress of measures. That is, it is possible for the management device 100 to support the work related to the implementation of measures regarding cybersecurity using checklists.

### Second Example Embodiment

Next, a management device according to a second example embodiment will be described. In the second example embodiment, another example related to the management device described in the first example embodiment will be further described. Duplicate contents with those of the first example embodiment will not be partially described.

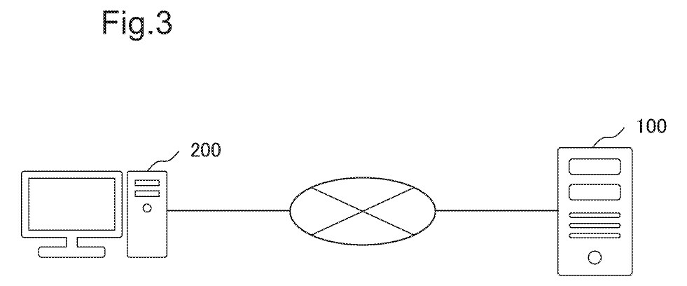

FIG. 3 is a diagram schematically illustrating an example of a configuration including a management device. As illustrated in FIG. 3, the management device 100 is communicably connected to a terminal device 200 via a wired or wireless network.

The terminal device 200 is a device used by the user. The user is, for example, a security practitioner of a project, a project owner, a security manager, or the like. The configuration communicably connected to the management device 100 is not limited to this example. For example, the management device 100 may be able to communicate with other devices.

Here, the management device 100 may be a device that performs processing such as project registration, registration of a checklist corresponding to a project, and checklist update according to an operation from the user. That is, the management device 100 may be a device that implements a management system for a checklist corresponding to a project. The management system may be implemented as a web application. For example, when the user logs in to the management system using the terminal device 200, the management device 100 may be able to present the checklist to the user via the terminal device 200. At this time, the management device 100 may cause the terminal device 200 to display an interface that receives an input by an operation from the user in various types of processing. In the present example embodiment, an example in which the management device 100 receives an input from the user via the terminal device 200 and presents information corresponding to various types of processing to the user via the terminal device 200 will be described.

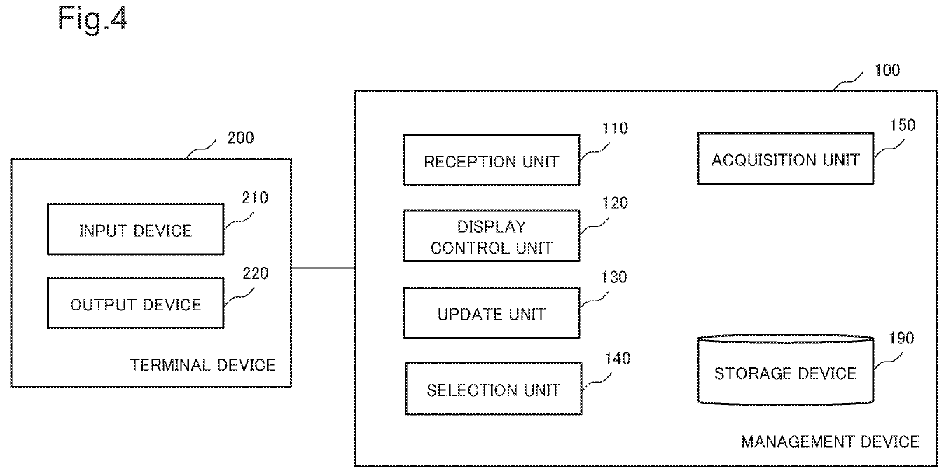

FIG. 4 is a block diagram including an example of a functional configuration of the management device 100. Specifically, FIG. 4 illustrates examples of functional configurations of the management device 100 and the terminal device 200.

The terminal device 200 includes an input device 210 such as a keyboard, a mouse, or a touch panel. The terminal device 200 includes an output device 220 such as a display and a speaker.

The management device 100 includes the reception unit 110 and the display control unit 120. In addition, the management device 100 includes an update unit 130, a selection unit 140, and an acquisition unit 150. The management device 100 also includes a storage device 190. A plurality of storage devices 190 may be provided. The storage device 190 may be an external device capable of communicating with the management device 100. The storage device 190 may exist both inside and outside the management device 100.

The storage device 190 stores various types of information. The storage device 190 may function as a database server. The storage device 190 stores a checklist and information on a project. Specifically, the storage device 190 stores information on a plurality of projects and associated checklists respectively corresponding to the projects.

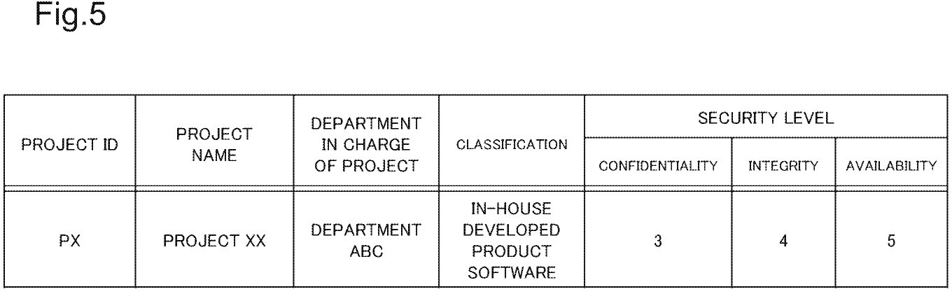

For example, the storage device 190 stores project information that is information on a project. The project information includes information registered for a project. FIG. 5 is a diagram illustrating an example of project information. In the example of FIG. 5, a project identifier (ID), a project name, a department in charge of the project, a classification, and a security level are associated. The project ID is information for identifying a project. The project name indicates the name of the project. The department in charge of the project indicates the organization that manages the project. The classification indicates the classification of the digital product to be developed in the project. The security level is information indicating the level of one or more elements related to cybersecurity required for the project. In this example, the levels of confidentiality, integrity, and availability are indicated as security levels. The security level may be indicated by one of five levels, from 1 to 5, for example. In the example of FIG. 5, the confidentiality level is 3, the integrity level is 4, and the availability level is 5. The project information exists for each project. The project information may be information registered by the user. Such project information may be associated with a checklist. Note that the information included in the project information is not limited to this example. For example, the project information may include information indicating whether the project is ongoing or completed, information indicating the current phase in an ongoing project, information indicating participating members of the project, etc.

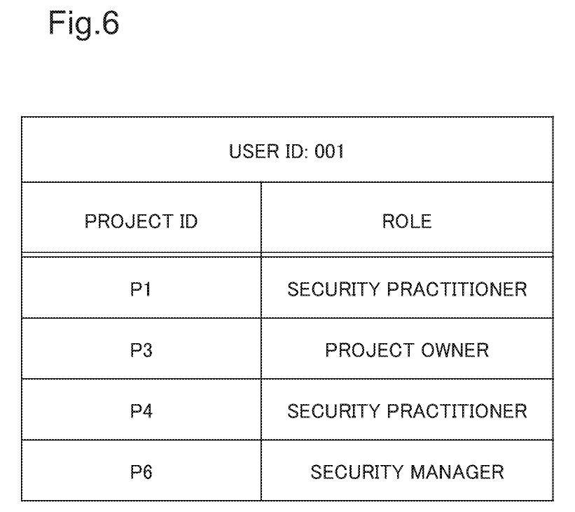

Furthermore, the storage device 190 may store information on the user. For example, role information of the user is stored in the storage device 190. The role information is information in which a project that the user is in charge of and the role of the user in the project are associated with each other. FIG. 6 is a diagram illustrating an example of the role information. Here, the user ID is information for identifying a user. The project ID is information for identifying a project. That is, in the example of FIG. 6, it can be seen that the user having the user ID “001” is in charge of four projects. Furthermore, in this example, the user’s roles in the projects the user is in charge of are illustrated. For example, it is indicated that the user is a security practitioner in the project with the project ID “P1”. A security practitioner is, for example, a role in charge of implementing measures for a project or filling out a checklist in accordance with the implementation of the measures. A project manager indicates a role for managing a project. A security manager is a role responsible for measures regarding cybersecurity for one or more projects. For example, the project manager and the security manager confirm completed checklists or monitor the state of the implementation of measures. The roles are not limited to these examples.

The management system implemented by the management device 100 may be a system that supports a workflow for confirming the implementation of measures. A workflow for confirming the implementation of measures is a business process related to confirmation of the implementation of measures. For example, the security practitioner fills out a checklist according to measures implemented for a project. After filling out the checklist, the security practitioner requests approval. The project owner or security manager confirms the state of implementation based on the completed checklist. For example, the project owner approves or returns the request depending on the state of implementation. The management device 100 is applicable in a situation in which such a workflow for confirming the implementation of measures is advanced. The workflow is not limited to this example.

The reception unit 110 receives various types of information input by the user’s operation. For example, the reception unit 110 receives the selection of a project. At this time, the display control unit 120 may present a list of information items indicating the project to the user. Here, the interface displayed by the display control unit 120 is referred to as output information. The input received by the reception unit 110 is not limited to this example. The reception unit 110 receives information input through the interface displayed by the display control unit 120.

The display control unit 120 displays various types of information. For example, the display control unit 120 causes the output device 220 of the terminal device 200 to display the output information. The display control unit 120 may change the output information to be displayed according to an operation by the user. The display control unit 120 may also change the output information to be displayed according to processing by a functional unit of the management device.

The update unit 130 updates the checklist, the project information, and the like. For example, the update unit 130 reflects the information based on the operation of the user in the checklist or project information. It is also possible for the update unit 130 to newly create project information based on an operation by the user. The update unit 130 is an example of an update means.

The selection unit 140 selects implementation items corresponding to a project. Depending on the content of the project, some of the implementation items included in a checklist may not need to be implemented. For example, the selection unit 140 selects implementation items to be implemented for the project from among all the implementation items in the checklist. Alternatively, the selection unit 140 may select implementation items that need not be implemented for the project from among all the implementation items in the checklist. The selection unit 140 is an example of a selection means.

The acquisition unit 150 acquires various types of information. For example, the acquisition unit 150 acquires information stored in the storage device 190. The present disclosure is not limited to this example, and the acquisition unit 150 may acquire various types of information from another device communicably connected to the management device 100. The acquisition unit 150 is an example of an acquisition means.

Next, a specific example related to the processing by the management device 100 will be described.

### Specific Example 1

Specific Example 1 is an example of processing in a case where the user inputs details regarding the implementation of measures to the checklist.

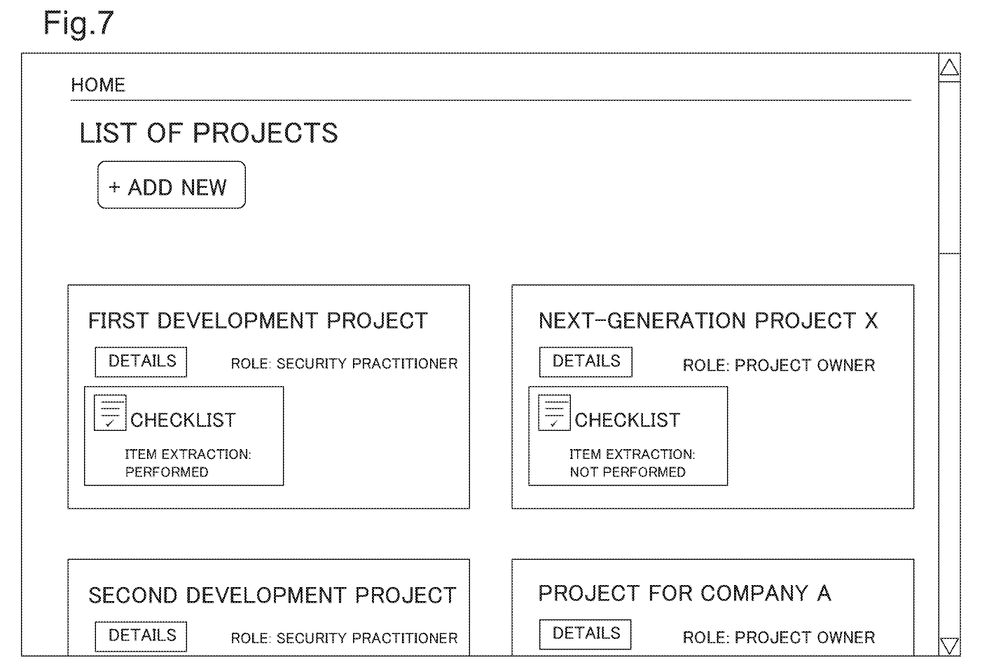

The display control unit 120 presents a list of information items indicating the project to the user. FIG. 7 is a first diagram illustrating an example of the output information. Specifically, FIG. 7 illustrates an example in which a list of information items indicating a project is displayed. The output information illustrated in FIG. 7 may be an example of a home screen when the user logs in to the management system. In the example of FIG. 7, four projects are illustrated. The user selects a desired project. For example, it is assumed that the user selects the “first development project” using the input device 210. The reception unit 110 receives an input of information indicating that the “first development project” is selected. In short, the reception unit 110 receives the selection of the “first development project”.

In this case, the display control unit 120 may present a list of information items indicating projects according to the user. Specifically, the display control unit 120 may display information indicating projects that the user is in charge of among a plurality of projects. For example, the acquisition unit 150 acquires the role information of the logged-in user from the storage device 190. The display control unit 120 identifies projects that the user is in charge of by using the role information of the user. Then, the display control unit 120 may present a list of information items indicating the identified projects. As a result, since this allows the management device 100 to present projects related to the user, it is possible to reduce the user’s effort to search for the desired project. Furthermore, in the example of FIG. 7, information indicating the role of the user in each project is also displayed. For example, for the “first development project”, it is indicated that the role of the user is a “security practitioner”. In this manner, the display control unit 120 may display the role of the user in each project.

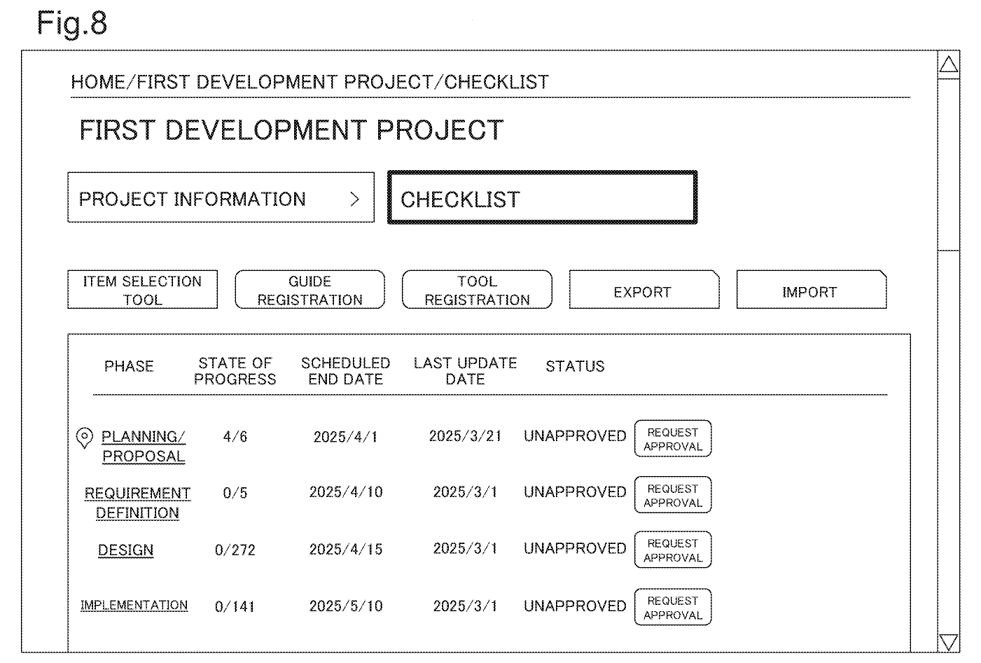

The display control unit 120 also displays a checklist corresponding to the selected project. FIG. 8 is a second diagram illustrating an example of the output information. Specifically, FIG. 8 illustrates information related to a checklist corresponding to the selected project. The output information illustrated in FIG. 8 may be an example of the screen after transition when the user selects a project in the management system.

In the example of FIG. 8, the state of the implementation of measures is illustrated for each phase of the “first development project”. Specifically, the state of progress, scheduled end date, last update date, and status are indicated for each phase. The state of progress indicates the state of the implementation of measures in the phase. In this example, the number of implementation items corresponding to the phase that have been handled is indicated as the state of progress. “Handled” indicates a state in which input to the checklist has been completed. The scheduled end date is a scheduled date on which inputs to the implementation items corresponding to the phase end. The scheduled end date may be information set by the user. The last update date indicates the date on which the checklist has been updated. The status indicates the state of advancement of the workflow for confirming the implementation of measures.

For example, in the “planning/proposal” phase, the state of progress indicates that four out of six implementation items have been handled. In addition, the scheduled end date is “Apr. 1, 2025”, and the last update date is “Mar. 21, 2025”. Further, the status is “not approved”. That is, it is indicated that approval has not yet been made for the “planning/proposal” phase.

In the example of FIG. 8, a mark is displayed in the “planning/proposal” phase. This indicates the current phase of the project. For example, the display control unit 120 identifies the current phase of the project based on the project information. Then, the display control unit 120 displays information indicating the ongoing phase. As a result, it is possible for the user to understand the state of the implementation of measures in more detail.

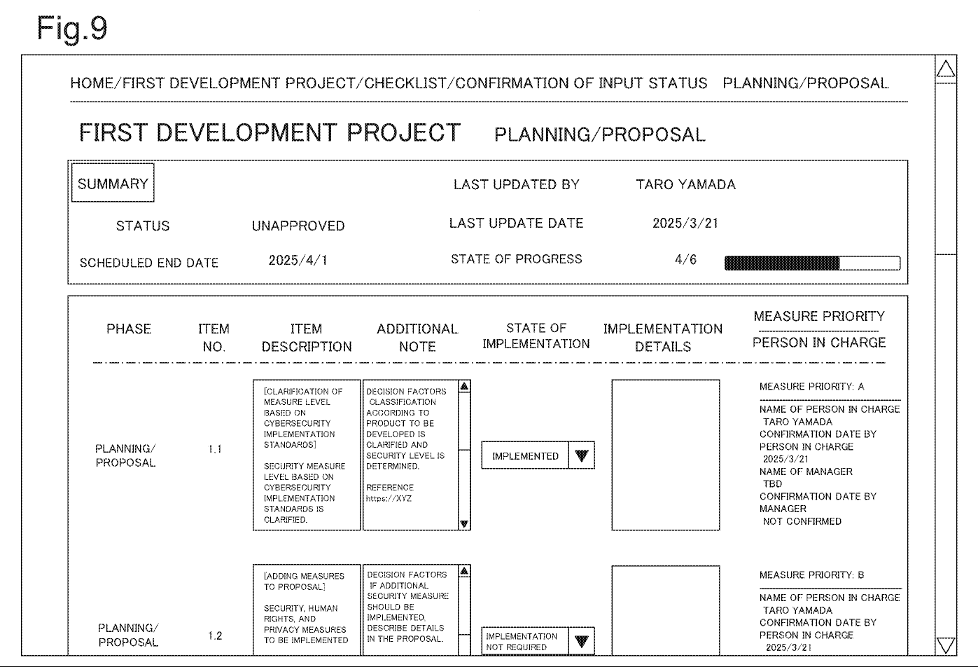

The reception unit 110 receives a selection of a phase. For example, the user selects a desired phase for the output information of FIG. 8. The display control unit 120 displays the implementation items corresponding to the selected phase. FIG. 9 is a third diagram illustrating an example of the output information. Specifically, FIG. 9 illustrates information on the implementation items corresponding to the selected phase. The output information illustrated in FIG. 9 may be an example of the screen after transition when the user selects a phase.

In the example of FIG. 9, implementation items indicating measures for the “planning/proposal” phase of the “first development project” are illustrated. Specifically, the phase, item number, item description, additional note, state of implementation, implementation details, measure priority, and person in charge are indicated for each implementation item. The phase indicates the phase to which the implementation item corresponds. The item number indicates a number for identifying the implementation item. The item description indicates the content of the measure. The additional note indicates additional description related to the measure. The state of implementation is information indicating whether the measure has been implemented. The implementation details are information indicating how the measure has been implemented or confirmed. The measure priority is information indicating the degree to which the measure should be implemented. The measure priority may be, for example, information determined according to a set security level. The person in charge is information regarding the user who has performed the confirmation work for the implementation of the measure.

For example, an item description and an additional description are specified in the implementation item of the item number “1.1”. A user such as a security practitioner confirms the measure implementation in a project while confirming the item description and the additional description. Then, the user inputs the state of implementation and implementation details. Examples of the state of implementation include “implemented”, “partially implemented”, “not implemented”, and “implementation not required”. The state of implementation is not limited to this example. Furthermore, the information indicated in an implementation item is not limited to the above-described example.

The reception unit 110 receives an input of the state of implementation or implementation details by the user's operation. The update unit 130 updates the checklist based on the input information. For example, the update unit 130 reflects the information input by the user in the checklist. In other words, the update unit 130 updates the input information for the checklist.

At this time, the update unit 130 may update the information on the person in charge. Specifically, in the example of FIG. 9, the update unit 130 reflects the name of the user who has input the state of implementation and the date when the state of implementation has been updated on the checklist. The display control unit 120 displays information that reflects these. For example, in the implementation item with the item number “1.1”, the name of the user who has input the state of implementation is displayed as “name of person in charge”. In addition, the date when the state of implementation is updated is displayed as the “confirmation date by person in charge”. At this time, the update unit 130 may update the state of progress. For example, in a case where the state of implementation is “implemented” or “implementation not required”, the update unit 130 updates the state of progress on the assumption that the implementation item has been handled. Furthermore, the update unit 130 may update the last update date. For example, the update unit 130 may update the last update date as the latest date when the input information was updated.

In this manner, the management device 100 may perform processing of inputting details regarding implementation of measures and processing of displaying various types of information according to input. Furthermore, the input may be performed by various methods and is not limited to this example.

Specifically, the management device 100 may input details regarding implementation of measures based on the setting information of the project. The setting information is information regarding features of the project. The setting information is, for example, phases to be carried out in a project. Some phases are unnecessary depending on the project. At this time, the management device 100 may perform input processing on the implementation items corresponding to the unnecessary phases.

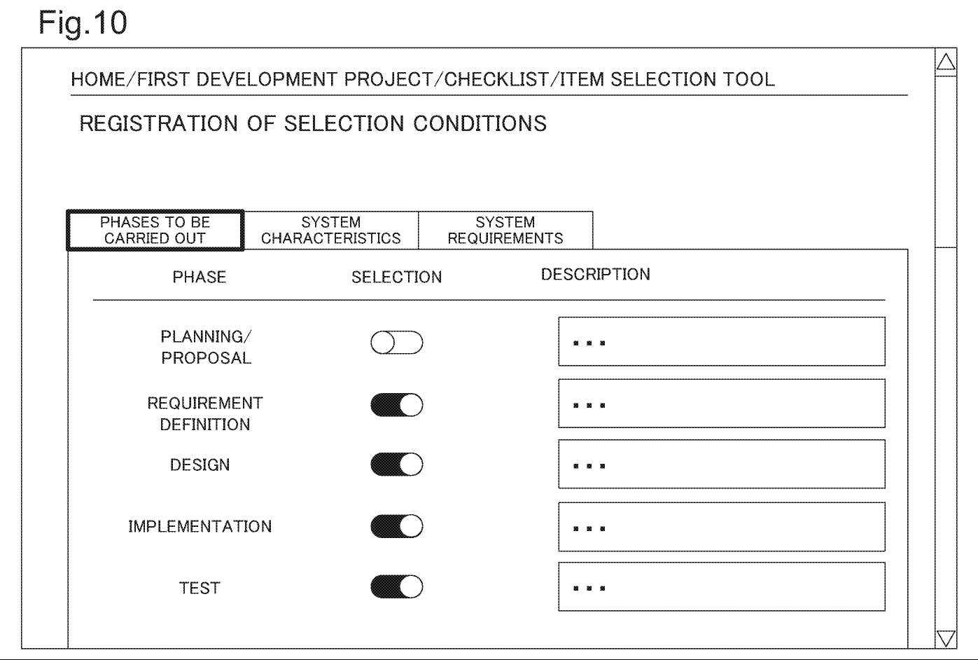

In this case, the reception unit 110 receives the input of the setting information. For example, the user selects an “item selection tool” for the output information of FIG. 8. At this time, the display control unit 120 may display output information as illustrated in FIG. 10. FIG. 10 is a fourth diagram illustrating an example of the output information. Specifically, FIG. 10 illustrates an example of an interface that receives settings for phases to be carried out in a project. In the example of FIG. 10, a selection button and a phase description are illustrated for each phase. It is possible for the user to select or cancel the selection of phases to be carried in the project by operating the selection buttons. For example, in the initial state when a project is started, all phases are selected. That is, it is assumed that the state in which all the phases are selected is the default setting. Then, the user cancels selections by operating the selection button for phases that are not to be carried out. In the example of FIG. 10, the selection of the “planning/proposal” phase is canceled. That is, the setting information of the project indicates that the “planning/proposal” phase is not a phase to be carried out. As described above, the reception unit 110 may receive the input of the setting information by receiving a setting operation related to features of the project.

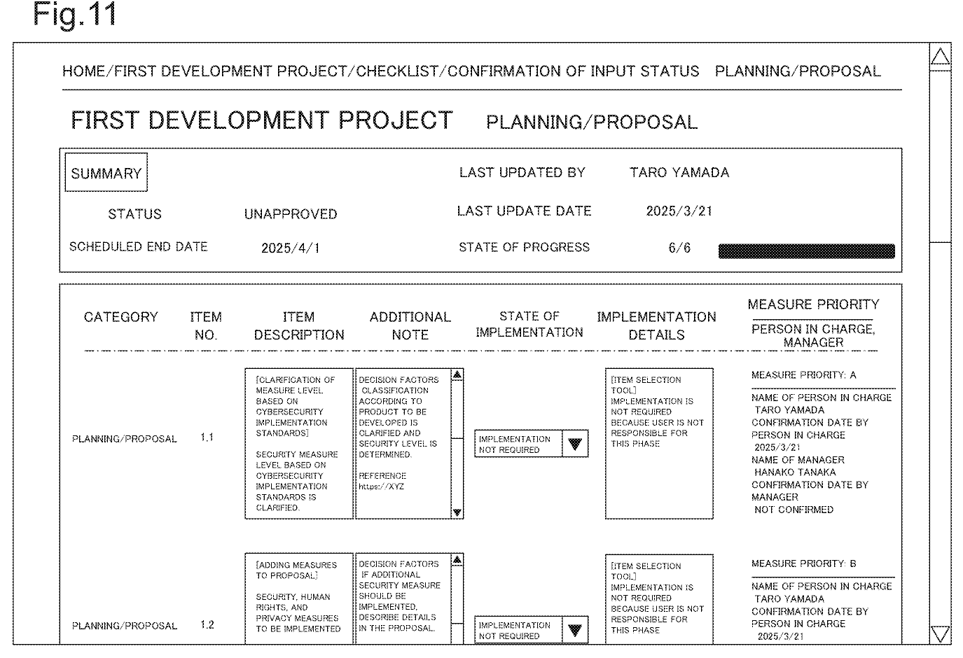

The selection unit 140 selects implementation items to be implemented for a project based on the input setting information. In the example shown in FIG. 10, the setting information indicates that the “planning/proposal” phase is not a phase to be carried out. That is, the implementation items in the “planning/proposal” phase do not need to be implemented. Therefore, the selection unit 140 identifies the implementation items that do not need to be implemented. Specifically, the selection unit 140 identifies the implementation items in the “planning/proposal” phase. Then, the update unit 130 inputs information indicating that implementation is not required for the identified implementation items. FIG. 11 is a fifth diagram illustrating an example of the output information. Specifically, FIG. 11 illustrates output information when information indicating that implementation is not required for the identified implementation items is input. In this example, “implementation not required” is input as the state of implementation for the implementation item in the “planning/proposal” phase. In addition, as the implementation details, the phrase “implementation is not required because the user is not responsible for this phase” is input. In this manner, the update unit 130 may input information indicating that implementation is not required for implementation items that need not be implemented.

Note that the processing of selecting the implementation items based on the setting information is not limited to this example. For example, the setting information may include other information. Specifically, the setting information may include system characteristics of the development target of the project. System characteristics indicate basic properties related to the development target. For example, system characteristics indicate, in the development target, whether a web application is included, whether design and implementation of a database are included, whether hardware design is included, whether a platform is constructed, and whether log design and operation are included. In addition, the system characteristics may indicate whether a framework such as NIST SP 800-53 is adopted in the development target. Furthermore, the system characteristics may indicate whether a cloud service is used in the development target, and the type of the cloud service to be used. In addition, the system characteristics may indicate whether a system such as an orchestrator is introduced. In addition, the system characteristics may indicate compatibility with a smart device such as a smartphone, and the type of the compatible OS. Furthermore, the system characteristics may indicate the development language used to develop the development target. Some measures may not be required to be implemented depending on the system characteristics of the development target in the project. At this time, the management device 100 may perform input processing on the implementation items of the unnecessary measures.

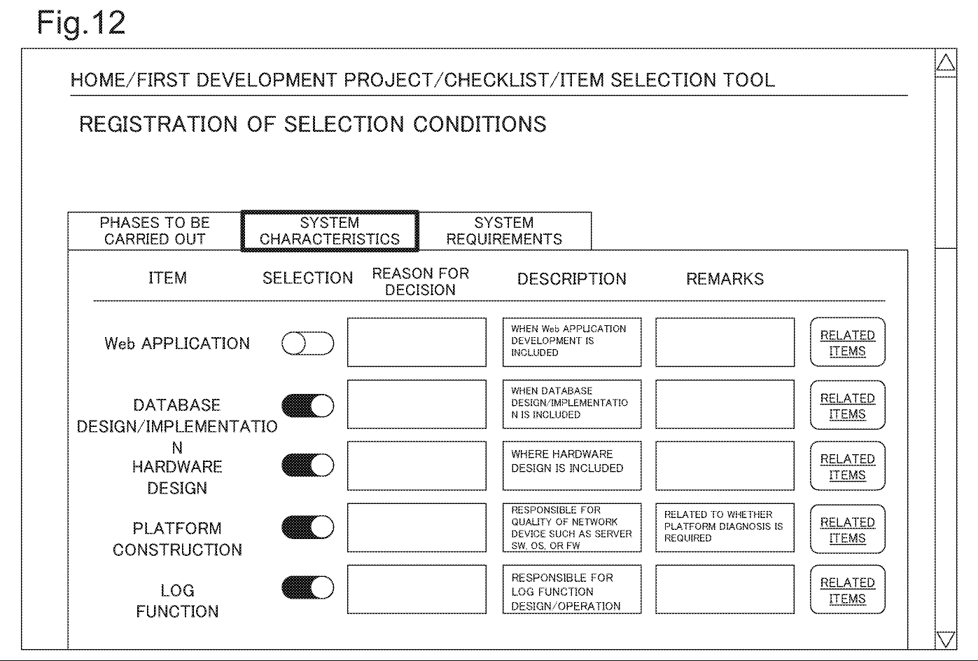

In this case, the reception unit 110 receives input of the setting information including system characteristics. For example, the user selects an “item selection tool” for the output information of FIG. 8. At this time, the display control unit 120 displays output information as illustrated in FIG. 10. Then, when “system characteristics” are selected, the display control unit 120 may display output information as illustrated in FIG. 12. FIG. 12 is a sixth diagram illustrating an example of the output information. Specifically, FIG. 12 illustrates an example of an interface for receiving settings of system characteristics. In the example of FIG. 12, a selection button, reason for the decision, description of the system characteristic, and remarks are shown for each system characteristic item. It is possible for the user to select or cancel the selection of each system characteristic of the development target by operating the selection buttons. In addition, it is possible for the user to input the reason for selecting or canceling the selection of each system characteristic in the cell for the reason of the decision. Reference information regarding the system characteristics is indicated in the remarks cells. Note that, in the remarks cells, for example, information indicating guidelines related to the system characteristics may be indicated.

For example, in the initial state when a project is started, all system characteristic items are selected. That is, it is assumed that the state in which all the items are selected is the default setting. Then, the user operates the selection buttons of the system characteristics irrelevant to the development target to cancel their selections. In the example of FIG. 12, the item “web application” is canceled. This indicates that no web application is included in the development target of the project. That is, it is indicated that the setting information of the project does not include the system characteristic “web application”. Therefore, in the project, it is not necessary to implement measures required when the system characteristic is “web application”.

Therefore, the selection unit 140 identifies the implementation items that do not need to be implemented. Specifically, the selection unit 140 identifies the implementation items of measures required when the system characteristic is “web application”. The storage device 190 may store characteristic correspondence information in which system characteristics and implementation items related to the system characteristics are associated with each other in advance. For example, the selection unit 140 uses the characteristic correspondence information to identify the implementation items of the measures to be implemented when a web application is included in the development target. Then, the update unit 130 inputs information indicating that implementation is not required for the identified implementation items.

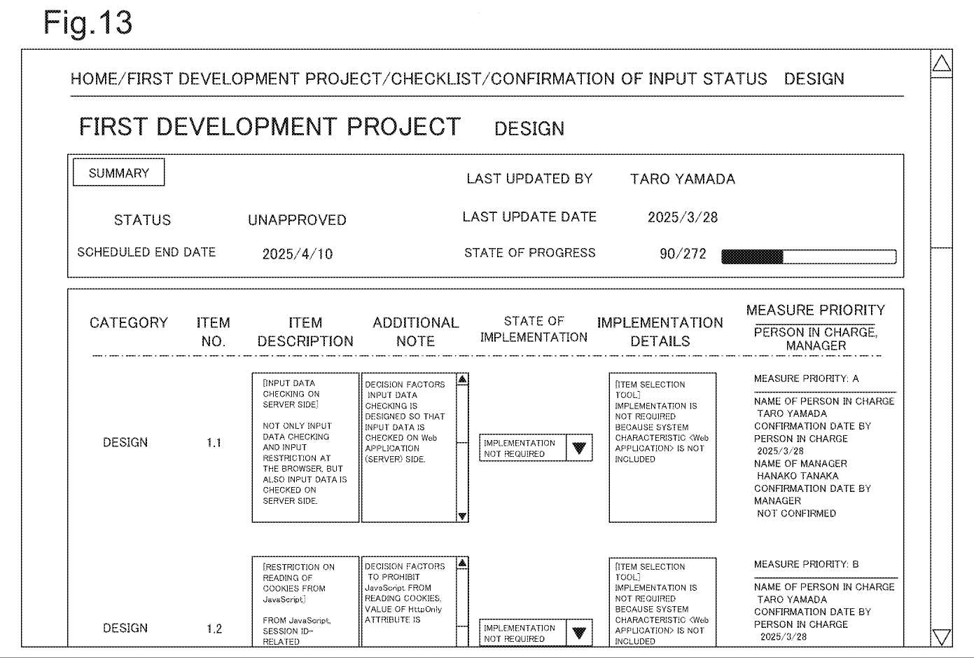

FIG. 13 is a seventh diagram illustrating an example of the output information. Specifically, FIG. 13 illustrates output information when information indicating that implementation is not required is input for the identified implementation items. In this example, “implementation not required” is input as the implementation status of the implementation items of the measures required when the system characteristic is “web application”. In addition, as the implementation details, the phrase “implementation is not required because the system characteristic <Web Application> is not included” is input.

Furthermore, the setting information may include system requirements for the development target in the project. System requirements indicate functions related to the development target. For example, system requirements indicate whether requirements related to an identity authentication function are included in the development target, whether requirements related to network protection are included, whether requirements related to a data protection function are included, whether requirements related to availability measures are included, and the like. The requirements for an identity authentication function include, for example, password authentication, single sign-on, one-time password authentication, media-based authentication, multi-factor authentication, and biometric authentication. The requirements for network protection include, for example, Internet connection, introduction of a network monitoring device, encrypted communication, session management, remote wireless access security, construction of a quarantine network, introduction of a wireless LAN, construction of a demilitarized zone (DMZ), use of network address translation (NAT) or network address port translation (NAPT), use of a proxy, use of a virtual local area network (VLAN), use of security architecture for Internet protocol (IPSec), use of secure sockets layer (SSL) or transport layer security (TLS), and use of point to point tunneling protocol (PPTP). The requirements regarding a data protection function include, for example, use of an electronic signature and encryption of stored information and a database. The requirements regarding availability measures include, for example, availability of communication services and protection from service disruption, backup, and redundancy.

Some measures may not be required to be implemented depending on the system requirements for the development target in the project. At this time, the management device 100 may perform input processing on the implementation items of the unnecessary measures.

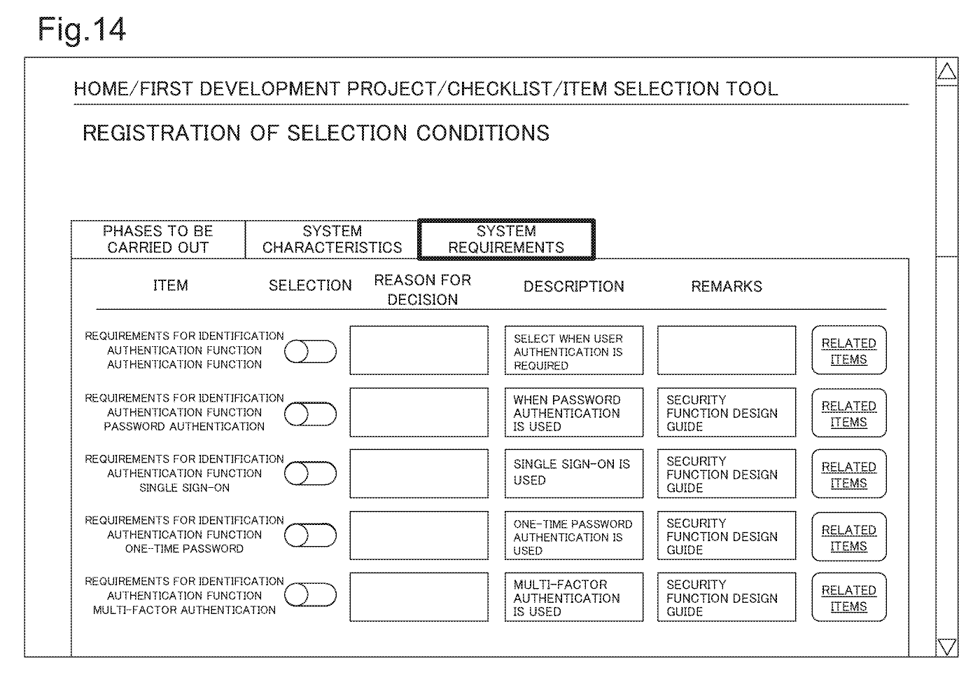

In this case, the reception unit 110 receives input of the setting information including system requirements. For example, the user selects an “item selection tool” for the output information of FIG. 8. At this time, the display control unit 120 displays output information as illustrated in FIG. 10. Then, when “system requirements” are selected, the display control unit 120 may display output information as illustrated in FIG. 14. FIG. 14 is an eighth diagram illustrating an example of the output information. Specifically, FIG. 14 illustrates an example of an interface for receiving settings of system requirements. In the example of FIG. 14, a selection button, reason for the decision, description of the system requirement, and remarks are shown for each system requirement item. It is possible for the user to select or cancel the selection of each system requirement of the development target by operating the selection buttons. In addition, it is possible for the user to input the reason for selecting or canceling the selection of each system requirement in the cell for the reason of the decision. Reference information regarding the system requirements is indicated in the remarks cells. Note that, in the remarks cells, for example, information indicating guidelines related to the system requirements may be indicated.

For example, in the initial state when a project is started, all system requirement items are selected. That is, it is assumed that the state in which all the items are selected is the default setting. Then, the user operates the selection buttons of the system requirements irrelevant to the development target to cancel their selections. In the example of FIG. 14, all the items of the “requirements for identity authentication function” are canceled. This indicates that an identity authentication function is not adopted for the development target of the project. That is, it is indicated that the setting information of the project does not include the system requirement "identity authentication function”. Therefore, in the project, it is not necessary to implement measures related to the identity authentication function.

Therefore, the selection unit 140 identifies the implementation items that do not need to be implemented. Specifically, the selection unit 140 identifies the implementation items of measures required when the “identity authentication function” is adopted as a system requirement. The storage device 190 may store requirement correspondence information in which system requirements and implementation items related to the system requirements are associated with each other in advance. For example, the selection unit 140 uses the requirement correspondence information to identify the implementation items of the measures to be implemented when an identity authentication function is included in the development target. Then, the update unit 130 inputs information indicating that implementation is not required for the identified implementation items.

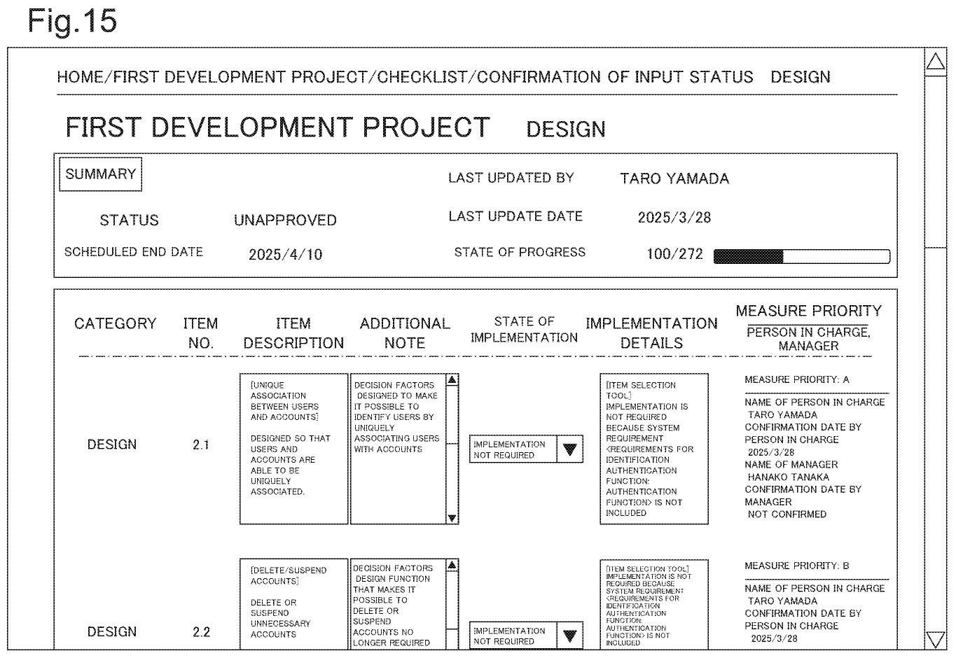

FIG. 15 is a ninth diagram illustrating an example of the output information. Specifically, FIG. 15 illustrates output information when information indicating that implementation is not required is input for the identified implementation items. In this example, “implementation not required” is input as the implementation status of the implementation items of the measures required when an “identity authentication function” is adopted as a system requirement. In addition, as the implementation details, the phrase “implementation is not required because the system requirement <Requirements for Identification Authentication Function: Authentication Function> is not included” is input.

As described above, the setting information may be information indicating at least one of phases to be carried out in a project, system characteristics of the development target in a project, and system requirements for the development target in a project. The setting information may include further information.

Furthermore, the management device 100 may input details regarding the implementation of measures based on information indicating an implementation support resource used to implement the measures. An implementation support resource is a resource for supporting the implementation of measures. An example of an implementation support resource is a guideline for a measure related to cybersecurity. A guideline is a guide that compiles recommendations for organizations or the like to reduce risks related to cybersecurity and protect information assets, best practices for implementing measures, or the like. A security practitioner may implement measures while checking such a guideline. The management device 100 may perform input processing on the implementation items corresponding to the guideline based on information indicating the guideline that has been used to implement measures.

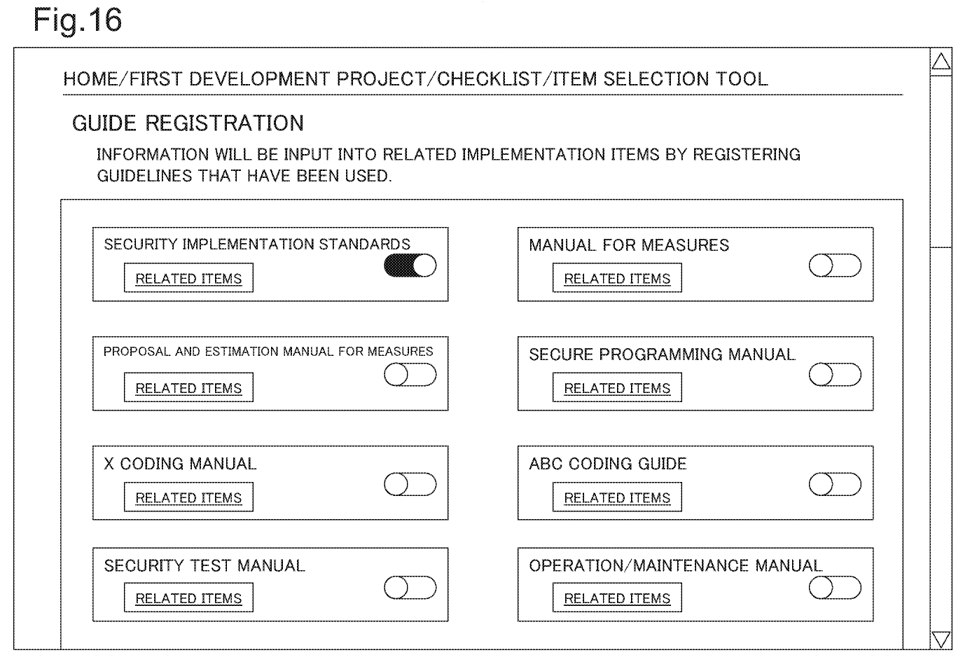

Specifically, the reception unit 110 receives an input of information indicating the implementation support resource. For example, the user selects “guideline registration” for the output information of FIG. 8. At this time, the display control unit 120 may display output information as illustrated in FIG. 16. FIG. 16 is a tenth diagram illustrating an example of the output information. Specifically, FIG. 16 illustrates an example of an interface for registration of guidelines that have been used to implement measures. The user is allowed to select the guidelines that have been used to implement measures. In the example of FIG. 16, the item “security implementation standards” is selected. In this manner, the reception unit 110 may receive the input of information indicating the implementation support resource by receiving the operation of selecting the implementation support resource that has been used.

The selection unit 140 selects an implementation item corresponding to the input information indicating the implementation support resource. In the example of FIG. 16, “security implementation standards” is indicated as the information indicating the implementation support resource. That is, the implementation items corresponding to the “security implementation standards” may be already implemented. Therefore, the selection unit 140 identifies the implementation items that may be already implemented. Specifically, the selection unit 140 identifies the implementation items corresponding to "security implementation standards”. The storage device 190 may store resource correspondence information in which information indicating implementation support resources and implementation items related to the implementation support resources are associated with each other in advance. In this case, the resource correspondence information includes information in which information indicating guidelines is associated with implementation items related to the guidelines. The selection unit 140 may identify implementation items by using information indicating an implementation support resource and the resource correspondence information.

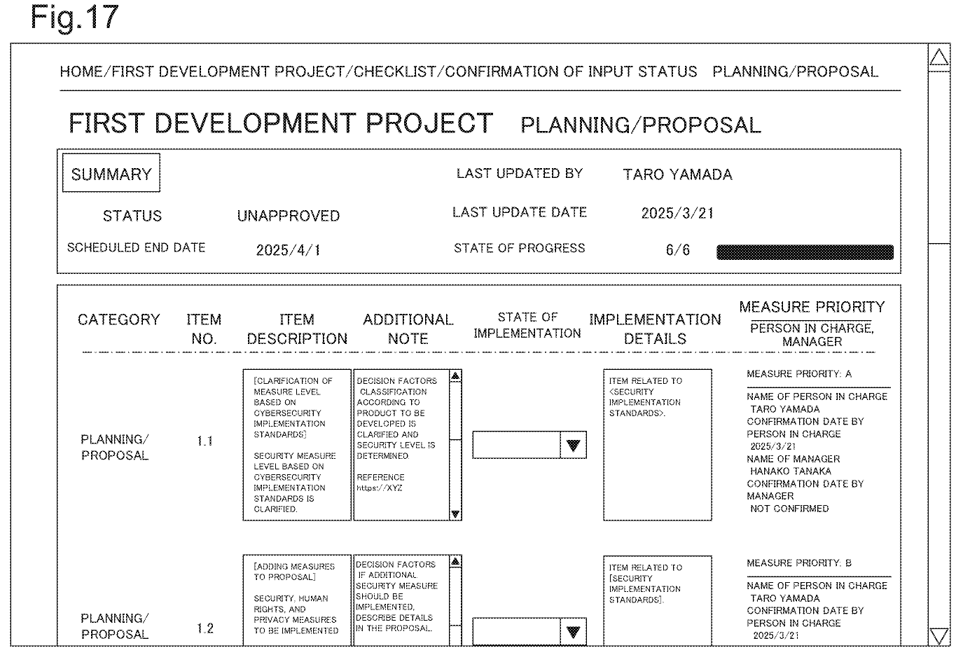

Then, the update unit 130 inputs information indicating that the identified implementation items may be already implemented. FIG. 17 is an eleventh diagram illustrating an example of the output information. Specifically, FIG. 17 illustrates output information when information indicating that the identified implementation items may be already implemented is input. In this example, as the implementation details for the implementation item in the “planning/proposal” phase, the following phrase is input: “This is an item related to <Security Implementation Standards>”. This allows the user to recognize that the implementation item is related to the guideline called “security implementation standards”. In addition, in this example, “implemented” is not input to the state of implementation. This is because even if the user has implemented the measure using the guideline, the user may not have implemented the entire guideline. Note that the present disclosure is not limited to this example, and the update unit 130 may input information indicating that the implementation item related to the guideline is already implemented.

Note that the processing of inputting details regarding the implementation of measures based on information indicating the implementation support resources is not limited to this example. For example, the information indicating the implementation support resources may include other information. Specifically, the information indicating the implementation support resources may include information indicating tools for implementing cybersecurity measures. One example of a tool for implementing a cybersecurity measure is a hardening tool. A hardening tool is software for enhancing security of systems, networks, and the like. Hardening tools automatically execute various measures related to cybersecurity. Therefore, when such a tool is used, the implementation items corresponding to the measures implemented by the used tool are already implemented. Therefore, the implementation items corresponding to the tool may be identified as implementation items that have already been implemented.

Specifically, the reception unit 110 receives an input of information indicating the implementation support resource. In this case, for example, the user selects “tool registration” for the output information of FIG. 8. At this time, the display control unit 120 may display an interface for the registration of a tool used in the implementation of a measure, similarly to the output information illustrated in FIG. 16. This allows the user to select the tool that has been used to implement the measure. Then, the selection unit 140 selects implementation items corresponding to the input information indicating the implementation support resource. In this case, the selection unit 140 identifies the implementation items corresponding to the tool as implementation items that have already been implemented. The storage device 190 may store tool correspondence information in which tools and implementation items related to the tools are associated with each other in advance. The selection unit 140 may identify the implementation items by using information indicating a tool included in the information indicating the implementation support resource and the tool correspondence information. Then, the update unit 130 may input information indicating that the identified implementation items related to the tool are already implemented.

As described above, the implementation support resource may be at least one of a guideline for a cybersecurity measure and a tool for implementing a cybersecurity measure. The implementation support resource is not limited to this example.

### Specific Example 2

Specific Example 2 is an example of processing in a situation in which such a workflow for confirming the implementation of measures is advanced.

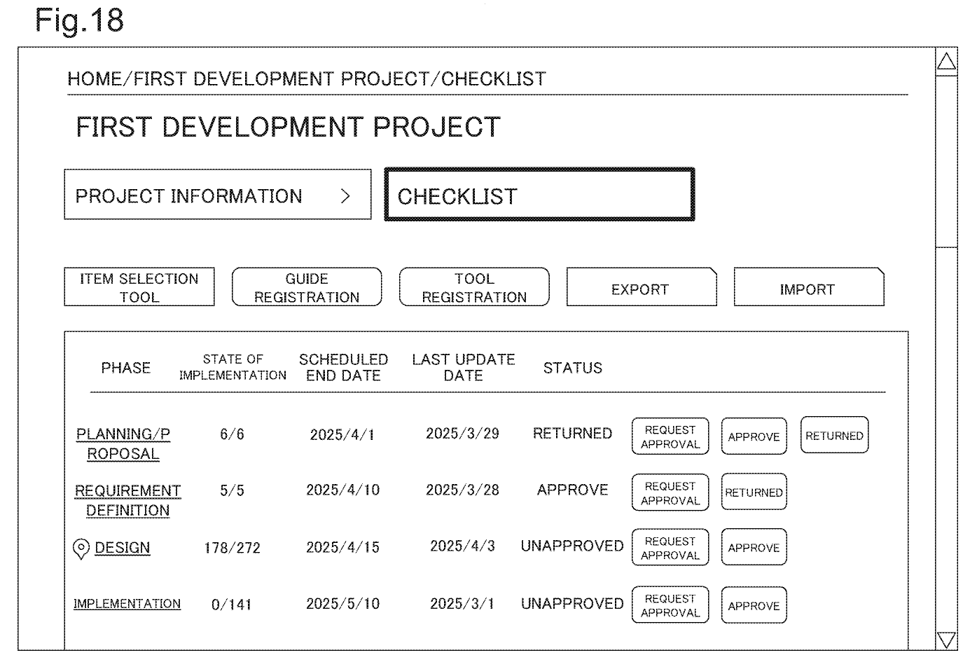

The display control unit 120 displays a checklist corresponding to the selected project for the user. At this time, the display control unit 120 may display instruction information. The instruction information is information indicating instructions related to the progress of the workflow for confirming the implementation of measures. FIG. 18 is a twelfth diagram illustrating an example of the output information. Specifically, FIG. 18 illustrates information related to checklists respectively corresponding to the selected project. In this example, buttons such as “request approval”, “approve”, and “return” are illustrated. These buttons correspond to examples of the instruction information. The instruction information is selected by the user according to the workflow. The reception unit 110 receives the input of the instruction information in response to the selection of the instruction information.

For example, after filling out the checklist, the security practitioner requests approval from the project owner. At this time, the security practitioner selects the instruction information indicating the “request approval”. When the reception unit 110 receives the input of the instruction information indicating the approval request, a notification indicating the approval request is sent to the project owner. For example, the display control unit 120 activates a mailer and displays a mail addressed to the project owner. At this time, the mail contains a text indicating the approval request. When the approval request is made, the update unit 130 updates the status. For example, in the example of FIG. 18, when an approval request is made for the “design” phase, the update unit 130 updates the status of the “design” phase to “pending approval”. In this manner, the update unit 130 may update the status in response to the input of the instruction information.

Furthermore, the project owner confirms the checklist for the phase in which the approval request has been made, and approves or returns it At this time, the reception unit 110 receives an input of instruction information indicating “approve” or “return”. At this time, for example, the display control unit 120 activates a mailer and displays a mail addressed to the security practitioner. When the request is approved or returned, the update unit 130 updates the status.

Note that the display mode of the instruction information may vary depending on the situation. For example, the security practitioner has no authority to approve checklists. That is, if the user is a security practitioner, there is no need to display the instruction information indicating “approve”. For example, the acquisition unit 150 acquires the role information of the user. Then, the display control unit 120 identifies the role of the user in the selected project. Then, when the identified role is a security practitioner, the display control unit 120 may not display the instruction information indicating “approve” and “return”. In this manner, the display control unit 120 may change the type of instruction information to be displayed according to the role of the user.

The display mode of the instruction information may also vary depending on the status. For example, when the status is “pending approval”, it is not necessary to display the instruction information indicating “request approval”. Furthermore, when the status is “unapproved”, it is not necessary to display the instruction information indicating “return”. In this manner, the display control unit 120 may change the type of instruction information to be displayed according to the status.

The instruction information is not limited to the examples described above. The instruction information may be any information indicating an action related to the progress of a workflow.

As described above, in the example of FIG. 18, the instruction information and status are displayed on a phase-by-phase basis. That is, it is possible to achieve a workflow related to approval on a phase-by-phase basis.

### Specific Example 3

Specific Example 3 is an example of processing when the user confirms the state of a plurality of projects.

The display control unit 120 may display various types of information regarding a plurality of projects to the user. Specifically, the display control unit 120 may display a list of project information items for a plurality of projects. A user such as a security manager may confirm the state of the projects. Therefore, the display control unit 120 displays a list of project information items for a plurality of projects that the user is in charge of.

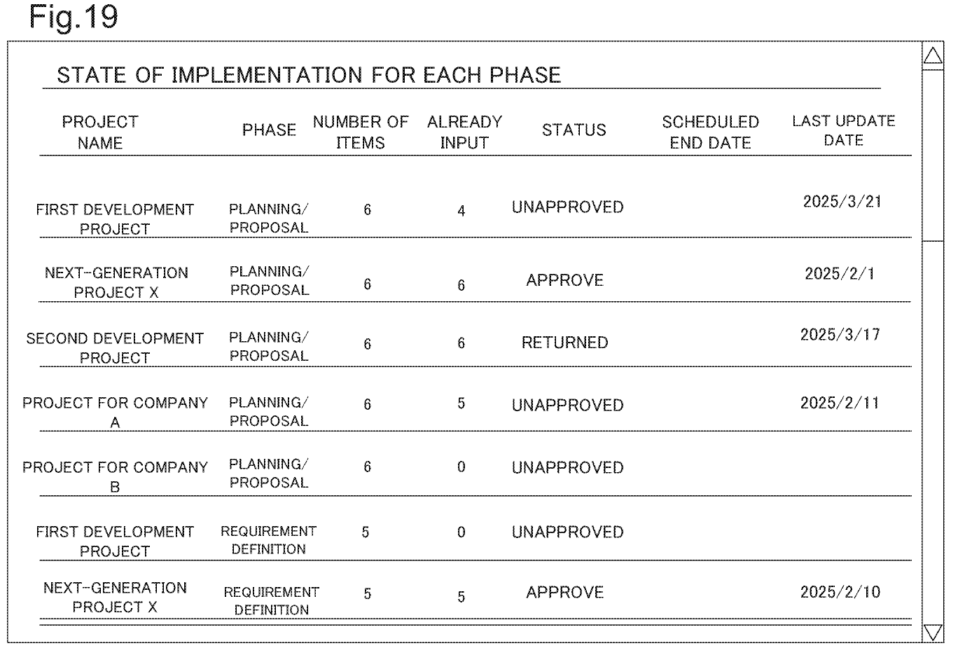

Furthermore, the display control unit 120 may display a list of states of implementation of a plurality of projects on a phase-by-phase basis. FIG. 19 is a thirteenth diagram illustrating an example of the output information. Specifically, FIG. 19 is a diagram illustrating a list of states of implementation of a plurality of projects. In the example of FIG. 19, states of implementation of a plurality of projects are illustrated on a phase-by-phase basis. Note that how to display the list is not limited to this example. Sorting may be possible under conditions desired by the user.

In this manner, by displaying the project information items and states of implementation in a list for a plurality of projects, it is possible for a user such as a security manager to centrally manage a plurality of projects.

As described above, the management device 100 of the second example embodiment receives the selection of a project related to development. In addition, the management device 100 displays a checklist including implementation items indicating measures regarding cybersecurity to be implemented for the selected project. Furthermore, the management device 100 displays, for each phase in the selected project, the implementation items and the state of the implementation of measures, based on the input information for the checklist.

As a result, it is possible for the management device 100 to present a checklist corresponding to a desired project to the user. Then, it is possible for the management device 100 to present the implementation items and the state of implementation corresponding to the phase in the selected project. For example, since the management device 100 allows the user to easily understand the correspondence between the phases in the desired project and the implementation items, it is possible to promote efficient checklist input. In addition, for example, since the management device 100 allows the user to easily understand the state of progress or the like of the measure in each phase of the desired project, it is possible to promote efficient monitoring of the progress of measures. That is, it is possible for the management device 100 to support the work related to the implementation of measures regarding cybersecurity using checklists.

In addition, the management device 100 may update the input information for the checklist. At this time, the management device 100 may receive an input of information indicating an implementation support resource that has been used to implement a measure to support the implementation and update the input information for implementation items corresponding to the input information indicating the implementation support resource.

Furthermore, the implementation support resource may be at least one of a guideline for a cybersecurity measure and a tool for implementing a cybersecurity measure. The management device 100 may update the input information for the implementation items corresponding to the measure implemented by using the implementation support resource.

As a result, since the management device 100 automatically provides inputs to implementation items corresponding to the implementation support resource that has been used, it is possible to reduce the time and effort for the user to fill out a checklist.

Furthermore, the management device 100 may select implementation items corresponding to a project. At this time, the management device 100 may receive an input of setting information that is information regarding features of a project and select implementation items to be implemented for the project based on the input setting information.

For example, the management device 100 selects implementation items that do not need to be implemented for the project based on the input setting information. Then, the management device 100 may input information indicating that implementation is not required for implementation items that need not be implemented.

For example, this allows the management device 100 to omit inputs to the implementation items that do not need to be implemented due to the features of the project. That is, it is possible for the management device 100 to reduce the time and effort for the user to fill out a checklist.

In addition, the management device 100 may display, for each phase of a project, a status indicating the state of advancement of a workflow for confirming the implementation of measures, and instruction information indicating instructions regarding the progress of the workflow. The management device 100 may change the type of instruction information to be displayed according to the status.

Furthermore, the management device 100 may acquire role information indicating the role of the user in the project. The management device 100 may change the type of instruction information to be displayed according to the role of the user.

As described above, since the management device 100 is capable of displaying instruction information according to various statuses, it is possible to suppress the occurrence of operations that are not suitable for the status. That is, it is possible for the management device 100 to suppress the occurrence of erroneous operations.

### First Modification

In the above examples, as the processing of selecting implementation items based on the setting information, processing of inputting information indicating that certain implementation items are not required to be implemented has been described. The processing of selecting the implementation items based on the setting information is not limited to this example.

For example, the selection unit 140 may extract implementation items that need to be implemented based on the setting information. The display control unit 120 may perform control so as not to display the implementation items that have not been extracted in the checklist of the project for which implementation items have been extracted.

### Second Modification

The implementation items of a checklist may be filtered and displayed. For example, the reception unit 110 receives an input of filtering conditions. The display control unit 120 may display implementation items according to the input conditions. Specifically, it is assumed that the reception unit 110 has received an input of a condition indicating that the measure priority has a predetermined value. In this case, the display control unit 120 displays, among the implementation items, only the implementation items with a measure priority of the predetermined value.

In order to suppress negative risks, it is conceivable to implement predetermined measures. For example, for a project related to development of a digital product, measures related to cybersecurity are implemented.

A checklist may be used to confirm whether measures are appropriately implemented. Specifically, personnel implementing measures may fill out the checklist depending on the state of implementation of the measures. Furthermore, a project owner, a security manager, or the like may determine the appropriateness of the measures implemented in the project based on the completed checklist.

In the work of confirming the implementation of measures using such a checklist, a burden may be placed on the worker. For example, a large number of implementation items may exist for measures. In such a case, it may take time and effort for the worker to grasp the state of implementation of measures. In addition, if the project has a plurality of stages, it may be difficult to grasp the correspondence between implementation items and stages, grasp the progress of the measures in each stage, etc.

In view of the above problems, an object of the present disclosure is to provide a management device and the like capable of supporting work related to implementation of measures regarding cybersecurity using a checklist.

According to the present disclosure, it is possible to support the work related to the implementation of measures regarding cybersecurity using checklists.

### Hardware Configuration Example of Management Device

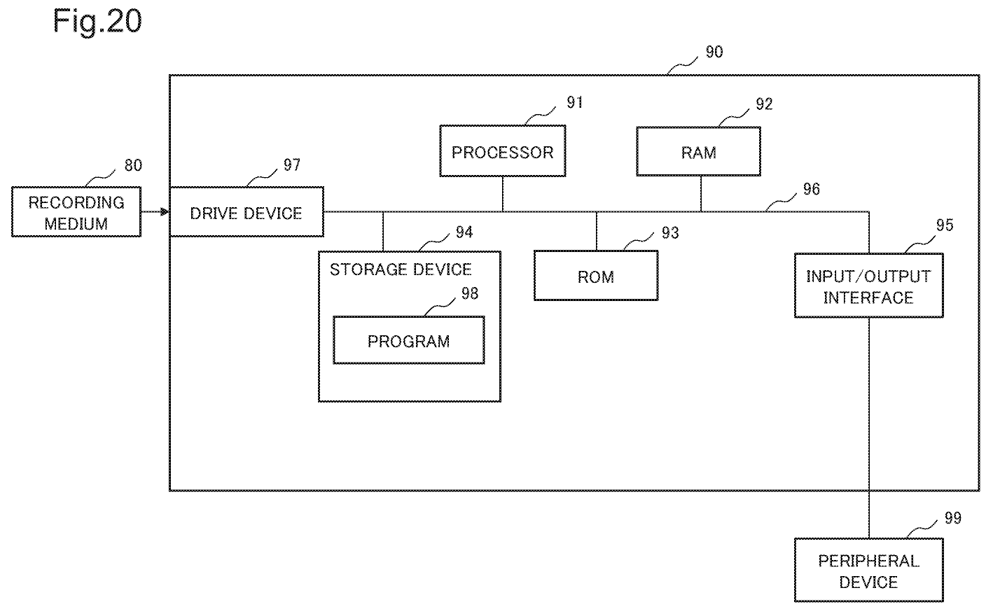

Hardware constituting the management devices of the first and second example embodiments will be described. FIG. 20 is a block diagram illustrating an example of a hardware configuration of a computer device constituting the management device according to each example embodiment. In a computer device 90, the management device and the management method described in each example embodiment and each modification example are implemented. For example, the management device and the like described in each example embodiment and each modification example may have the hardware configuration illustrated in FIG. 20.

As illustrated in FIG. 20, the computer device 90 includes a processor 91, a random access memory (RAM) 92, a read only memory (ROM) 93, a storage device 94, an input/output interface 95, a bus 96, and a drive device 97. The management device and the like may be implemented by a plurality of electric circuits.

The storage device 94 stores a program (computer program) 98. The processor 91 executes the program 98 of the present management device using the RAM 92. Specifically, for example, the program 98 includes a program that causes a computer to execute the processing described in the above example embodiments. When the processor 91 executes the program 98, the function of each configuration of the present management device is implemented. The program 98 may be stored in the ROM 93. The program 98 may be recorded in a recording medium 80 and read by the drive device 97 or may be transmitted from an external device (not illustrated) to the computer device 90 via a network (not illustrated).

The input/output interface 95 exchanges data with a peripheral device (such as a keyboard, a mouse, or a display device) 99. The input/output interface 95 functions as means for acquiring or outputting data. The bus 96 connects the components with each other.

Various modifications to the management device are possible. For example, it is possible for each of the components included in the management device to be implemented as a dedicated device. It is possible for the management device to be implemented based on a combination of a plurality of devices.

A processing method for causing a recording medium to record a program for implementing each component in the function of each example embodiment, reading the program recorded in the recording medium as a code, and causing a computer to execute the program is also included in the scope of each example embodiment. That is, a computer-readable recording medium is also included in the scope of each example embodiment. The recording medium recording the above-described program and the program itself are also included in each example embodiment.

The recording medium is, for example, a floppy (registered trademark) disk, a hard disk, an optical disk, a magneto-optical disk, a compact disc (CD)-ROM, a magnetic tape, a nonvolatile memory card, or a ROM, but is not limited to this example. The program recorded in the recording medium is not limited to a program for executing processing by itself, and programs that run on an operating system (OS) to execute processing in cooperation with other software and functions of an extension board are also included in the scope of each example embodiment.

While the present invention has been particularly shown and described with reference to example embodiments thereof, the present invention is not limited to these example embodiments. It will be understood by those of ordinary skill in the art that various changes in form and details may be made therein without departing from the scope of the invention of the present application.

The above-described example embodiments and modification examples can be appropriately combined with each other.

### SUPPLEMENTARY NOTES

Some or all of the above example embodiments may be described as the following Supplementary Notes, but are not limited to the following.

### Supplementary Note 1

A management device including:
a reception means for receiving a selection of a project related to development; and
a display control means for displaying a checklist including one or more implementation items indicating one or more measures related to cybersecurity to be implemented for the selected project,
wherein the display control means displays, for each phase in the selected project, the one or more implementation items and a state of implementation of the one or more measures based on input information for the checklist.

### Supplementary Note 2

The management device according to Supplementary Note 1, further including an update means for updating the input information for the checklist,
wherein the reception means receives an input of information indicating an implementation support resource that has been used to implement at least one of the one or more measures to support the implementation of the measure, and
the update means updates input information for an implementation item corresponding to the information input to indicate the implementation support resource.

### Supplementary Note 3

The management device according to Supplementary Note 1 or 2, wherein
the implementation support resource is at least one of a guideline for a cybersecurity measure and a tool for implementing a cybersecurity measure, and
the update means updates input information for an implementation item corresponding to the measure implemented by using the implementation support resource.

### Supplementary Note 4

The management device according to any one of Supplementary Notes 1 to 3, further including a selection means for selecting the one or more implementation items corresponding to the project,
wherein the reception means receives an input of setting information that is information related to a feature of the project, and
the selection means selects the one or more implementation items to be implemented for the project based on the input setting information.

### Supplementary Note 5

The management device according to Supplementary Note 4, further including an update means for updating the input information for the checklist, wherein the selection means selects an implementation item that is not required to be implemented for the project based on the input setting information, and the update means inputs information indicating that implementation is not required for the implementation item that is not required to be implemented.

### Supplementary Note 6

The management device according to Supplementary Note 4 or 5, wherein
the setting information indicates a setting of at least one of a phase to be carried out in the project, system characteristics of a development target of the project, and system requirements for the development target of the project, and a security level required for the project.

### Supplementary Note 7

The management device according to any one of Supplementary Notes 1 to 6, wherein
the display control means displays, for each phase of the project, a status indicating a state of advancement of a workflow for confirming implementation of the one or more measures, and instruction information indicating an instructions related to progress of the workflow, and
the display control means changes a type of the instruction information to be displayed according to the status.

### Supplementary Note 8

The management device according to Supplementary Note 7, further including an acquisition means for acquiring role information indicating a role of a user in the project,
wherein the display control means changes a type of the instruction information to be displayed according to the role of the user.

### Supplementary Note 9

A management method including:
receiving a selection of a project related to development; and
displaying a checklist including one or more implementation items indicating one or more measures related to cybersecurity to be implemented for the selected project,
wherein the displaying includes displaying, for each phase in the selected project, the one or more implementation items and a state of implementation of the one or more measures based on input information for the checklist.

### Supplementary Note 10

A program that causes a computer to execute:
processing of receiving a selection of a project related to development;
and processing of displaying a checklist including one or more implementation items indicating one or more measures related to cybersecurity to be implemented for the selected project,
wherein the processing of displaying includes displaying, for each phase in the selected project, the one or more implementation items and a state of implementation of the one or more measures based on input information for the checklist.

Some or all of the configurations described in Supplementary Notes 2 to 8 dependent on the above-described Supplementary Note 1 can also be dependent on Supplementary Notes 9 and 10 by the same dependency relationship as in Supplementary Notes 2 to 8. Some or all of the configurations described as a Supplementary Note can be similarly dependent on various types of hardware and software, various recording means for recording software, or various systems, without departing from the above-described example embodiments.

1. A management device comprising:
at least one memory configured to store instructions; and
at least one processor configured to execute the instructions to:
receive a selection of a project related to development; and
display a checklist including one or more implementation items indicating one or more measures related to cybersecurity to be implemented for the selected project,
wherein the at least one processor is further configured to display, for each phase of the selected project, the one or more implementation items and a state of implementation of the one or more measures based on input information for the checklist.

2. The management device according to claim 1, wherein the at least one processor is further configured to execute the instructions to:
update the input information for the checklist,
receive an input of information indicating an implementation support resource that has been used to implement at least one of the one or more measures to support the implementation of the measure, and
update input information for an implementation item corresponding to the information input to indicate the implementation support resource.

3. The management device according to claim 2, wherein
the implementation support resource is at least one of a guideline for a cybersecurity measure and a tool for implementing a cybersecurity measure, and
the at least one processor is further configured to execute the instructions to:
update input information for an implementation item corresponding to the measure implemented by using the implementation support resource.

4. The management device according to claim 1, wherein the at least one processor is further configured to execute the instructions to:
select the one or more implementation items corresponding to the project,
receive an input of setting information that is information related to a feature of the project, and
select the one or more implementation items to be implemented for the project based on the input setting information.

5. The management device according to claim 4, wherein the at least one processor is further configured to execute the instructions to:
update the input information for the checklist,
select an implementation item that is not required to be implemented for the project based on the input setting information, and
input information indicating that implementation is not required for the implementation item that is not required to be implemented.

6. The management device according to claim 4, wherein
the setting information indicates a setting of at least one of a phase to be carried out in the project, system characteristics of a development target of the project, and system requirements for the development target of the project, and a security level required for the project.

7. The management device according to claim 1, wherein the at least one processor is further configured to execute the instructions to:
display, for each phase of the project, a status indicating a state of advancement of a workflow for confirming implementation of the one or more measures, and instruction information indicating an instruction related to progress of the workflow, and
change a type of the instruction information to be displayed according to the status.

8. The management device according to claim 7, wherein the at least one processor is further configured to execute the instructions to:
acquire role information indicating a role of a user in the project, and
change a type of the instruction information to be displayed according to the role of the user.

9. A management method comprising:
receiving a selection of a project related to development; and
displaying a checklist including one or more implementation items indicating one or more measures related to cybersecurity to be implemented for the selected project,
wherein the displaying includes displaying, for each phase of the selected project, the one or more implementation items and a state of implementation of the one or more measures based on input information for the checklist.

10. The management method according to claim 9, further comprising:
updating the input information for the checklist,
receiving an input of information indicating an implementation support resource that has been used to implement at least one of the one or more measures to support the implementation of the measure, and
updating input information for an implementation item corresponding to the information input to indicate the implementation support resource.

11. The management method according to claim 10, wherein:
the implementation support resource is at least one of a guideline for a cybersecurity measure and a tool for implementing a cybersecurity measure, and
the management method further comprising:
updating input information for an implementation item corresponding to the measure implemented by using the implementation support resource.

12. The management method according to claim 9, further comprising:
selecting the one or more implementation items corresponding to the project,
receiving an input of setting information that is information related to a feature of the project, and
selecting the one or more implementation items to be implemented for the project based on the input setting information.

13. The management method according to claim 12, further comprising:
updating the input information for the checklist,
selecting an implementation item that is not required to be implemented for the project based on the input setting information, and
inputting information indicating that implementation is not required for the implementation item that is not required to be implemented.

14. The management method according to claim 12, wherein
the setting information indicates a setting of at least one of a phase to be carried out in the project, system characteristics of a development target of the project, and system requirements for the development target of the project, and a security level required for the project.

15. The management method according to claim 9, further comprising:
displaying, for each phase of the project, a status indicating a state of advancement of a workflow for confirming implementation of the one or more measures, and instruction information indicating an instruction related to progress of the workflow, and
changing a type of the instruction information to be displayed according to the status.

16. The management method according to claim 15, further comprising:
acquiring role information indicating a role of a user in the project, and
changing a type of the instruction information to be displayed according to the role of the user.

17. A non-transitory computer-readable recording medium storing a program that causes a computer to execute:
receiving a selection of a project related to development; and
displaying a checklist including one or more implementation items indicating one or more measures related to cybersecurity to be implemented for the selected project,
wherein the displaying includes displaying, for each phase of the selected project, the one or more implementation items and a state of implementation of the one or more measures based on input information for the checklist.

18. The non-transitory computer-readable recording medium according to claim 17, wherein the program further causes the computer to execute:
updating the input information for the checklist,
receiving an input of information indicating an implementation support resource that has been used to implement at least one of the one or more measures to support the implementation of the measure, and
updating input information for an implementation item corresponding to the information input to indicate the implementation support resource.

19. The non-transitory computer-readable recording medium according to claim 18, wherein
the implementation support resource is at least one of a guideline for a cybersecurity measure and a tool for implementing a cybersecurity measure, and
the program further causes the computer to execute:
updating input information for an implementation item corresponding to the measure implemented by using the implementation support resource.

20. The non-transitory computer-readable recording medium according to claim 17, wherein the program further causes the computer to execute:
selecting the one or more implementation items corresponding to the project,
receiving an input of setting information that is information related to a feature of the project, and
selecting the one or more implementation items to be implemented for the project based on the input setting information.
